(19) United States
(12) Patent Application Publication
(10) Pub. No.: US 2015/0152252 A1
(43) Pub. Date: Jun. 4, 2015

(54) Heat Shrinkable Material-Enclosed Porous Particle

(71) Applicant: Singtex Industrial Co., Ltd., New Taipei City (TW)

(72) Inventors: Kuo-Chin Chen, New Taipei City (TW); Lai-Hung Wan, New Taipei City (TW); Yu-Ping Chuang, New Taipei City (TW); Po-Han Huang, New Taipei City (TW); Li-Jen Pan, New Taipei City (TW)

(21) Appl. No.: 14/558,903

(22) Filed: Dec. 3, 2014

Related U.S. Application Data
(60) Provisional application No. 61/911,712, filed on Dec. 4, 2013.

(51) Int. Cl. C08K 7/22; C08L 67/02; C08L 23/12; C08L 77/00; C08L 33/00; C09D 101/00; C08L 1/00; C09D 123/12; C09D 177/00; C09D 133/00; C09D 175/04; C09D 127/20; C08L 75/04

(52) U.S. Cl. CPC C08K 7/22; C09D 127/20; C08L 67/02; C08L 23/12; C08L 77/00; C08L 33/00; C08L 75/04; C08L 1/00; C09D 123/12; C09D 177/00; C09D 133/00; C09D 175/04; C09D 101/00

(57) ABSTRACT

A heat shrinkable material-enclosed porous particle including a porous body that has a plurality of pores and a heat shrinkable material that encloses the porous body is disclosed. A method for preparing heat shrinkable material-enclosed porous particles is also disclosed.

### CROSS-REFERENCE TO RELATED APPLICATION

This application claims priority to U.S. provisional application no. 61/911,712, filed on Dec. 4, 2013.

### FIELD OF THE INVENTION

This invention relates to a porous particle, more particularly to a heat shrinkable material-enclosed porous particle.

### BACKGROUND OF THE INVENTION

Conventional fabric products, such as fibers, yarns or filaments, may contain porous particles, such as active carbon, for increasing specific area of the fabric products or providing certain functions, such as warming. For instance, the porous particles may be added into a melt of a polymeric material, such as poly(ethylene terephthalate) (PET), for forming a filament. However, the pores in the porous particles are likely to be clogged with the polymeric material during formation of the filament, which may deteriorate the functions of the porous particles in the filament.

### SUMMARY OF THE INVENTION

Therefore, an object of the present invention is to provide a heat shrinkable material-enclosed porous particle that at least alleviates the aforesaid drawback associated with the prior art.

According to one aspect of this invention, a heat shrinkable material-enclosed porous particle includes a porous body that has a plurality of pores, and a heat shrinkable material film that encloses the porous body.

According to another aspect of this invention, a method for preparing heat shrinkable material-enclosed porous particles includes:

preparing a particle-containing composition that has a plurality of porous particles, each of which having a porous body with pores, a particle dispersing agent and a heat shrinkable material;

adding a solvent into the particle-containing composition to dissolve the heat shrinkable material to form a particle-containing solution;

subjecting the particle-containing solution to a wet milling process to reduce particle sizes of the porous particles; and

drying the particle-containing solution to remove the solvent and to permit formation of a heat shrinkable material film on the porous body of each of the porous particles such that the heat shrinkable material film encloses the porous body of each porous particle and covers a portion of the pores in the porous body.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic view of the embodiment of a heat shrinkable material-enclosed porous particle according to the present invention;

FIG. 2 is a schematic view to illustrate the embodiment in a state where the heat shrinkable material enclosing the porous particle is shrunk to expose the surface of a porous body of the porous particle;

FIG. 3 is a scanning electron microscope (SEM) photograph showing surface morphology of heat shrinkable material-enclosed porous particles which are applied to a polymeric substrate before a shrinking treatment; and

FIG. 4 is a scanning electronmicroscope (SEM) photograph showing the surface morphology of the heat shrinkable material-enclosed porous particles after the shrinking treatment.

### DETAILED DESCRIPTION OF THE EMBODIMENT

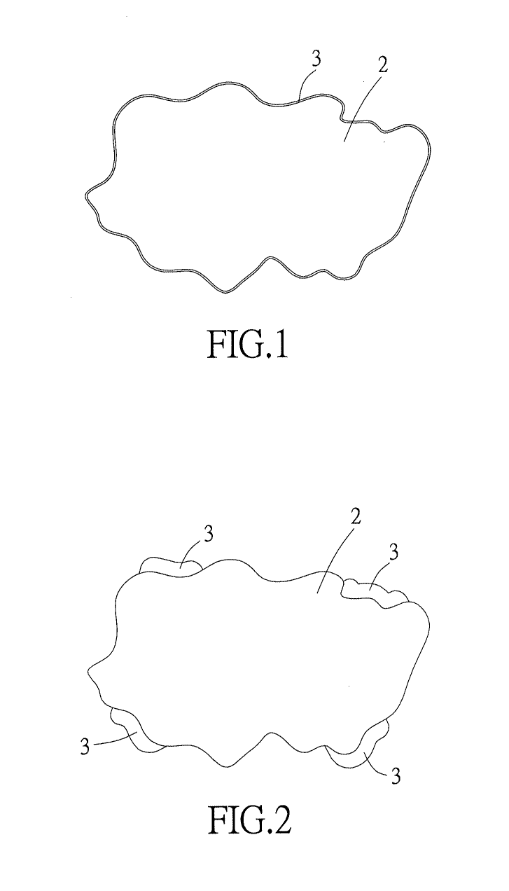

Referring to FIG. 1, the embodiment of a heat shrinkable material-enclosed porous particle according to the present invention includes a porous body 2 that has a plurality of pores, and a heat shrinkable material film 3 that encloses the porous body 2 in a manner that the heat shrinkable material film 3 substantially covers the pores of the porous body 2. The heat shrinkable material film 3 is shrinkable to expose a portion of the pores of the porous body 2 when heated to a shrinking temperature (see FIG. 2).

Examples of a material suitable for forming the porous body 2 may include, but are not limited to, zeolite, aluminosilicate, diatom, eggshell-originated calcium carbonate (CaCo₃), coffee residues with or without removal of coffee oil, carbonized coffee residues, sepiolite (magnesium silica), kaolin, carbon black, active carbon, talc and mixtures thereof.

The porous body 2 may have a particle size ranging from 5 nm to 50 μm, and preferably from 50 nm to 200 nm.

The porous body 2 may have a weight ratio relative to the heat shrinkable material film 3 ranging from 1:1 to 10:1, and preferably from 4:1 to 6:1.

The heat shrinkable material film 3 may have a layer thickness ranging from 5 nm to 500 nm, and preferably from 30 nm to 90 nm.

The embodiment of a method for preparing the heat shrinkable material-enclosed porous particles according to the present invention includes the steps of:

preparing a particle-containing composition that has a plurality of porous particles, each of which having the porous body 2 with pores, a particle dispersing agent and a heat shrinkable material;

adding a solvent into the particle-containing composition to dissolve the heat shrinkable material to form a particle-containing solution;

subjecting the particle-containing solution to a wet milling process to reduce particle sizes of the porous particles; and

drying the particle-containing solution to remove the solvent and to permit formation of the heat shrinkable material film 3 on the porous body 2 of each of the porous particles such that the heat shrinkable material film 3 encloses the porous body 2 of each porous particle and covers a portion of the pores in the porous body 2.

The porous bodies 2 of the porous particles may have an original particle size ranging from 10 μm to 1000 μm before the wet milling process.

The wet milling process is exemplified as, but not limited to, being conducted in a milling rotary drum that has a rotation speed ranging from 500 rpm to 5000 rpm, and preferably from 1000 rpm to 3000 rpm. Alternatively, a plurality of milling beads may be placed in the milling rotary drum for grinding the porous particles. The milling beads are exemplified to have a diameter ranging from 0.05 mm to 5 mm.

The heat shrinkable material may be made from a composition comprising tetrafluoroethylene, hexafluoropropylene and vinylidene fluoride. Examples of the heat shrinkable material include but are not limited to THV 221AZ, THV 500G, THV 340Z, THV 505ESDZ, THV 815, THV 510, THV 610G and THV 610 , which are available from 3M company.

The heat shrinkable material is advantageous in preventing the pores in the porous body 2 from being clogged by a material with which the heat shrinkable material-enclosed porous particle is mixed in the formation a polymeric product. For instance, in forming a PET filament, the PET material is melted in an extruder at a temperature of about 250° C., and is spun through a spinning die at a temperature of about 285° C. Hence, by selecting the heat shrinkable material that does not shrink at about 250° C., but is shrinkable at 285° C., clogging of the pores in the porous bodies 2 with the PET material is avoided in the extruder and a portion of the pores are exposed after shrinking of the heat shrinkable material caused by heating of the heat shrinkable material at about 285° C. at the spinning die.

Examples of the solvent include but are not limited to methyl ethyl ketone (MEK), toluene, alcohol, dimethylacetamide (DMAC), dimethylformamide (DMF), ethyl acetate, acetone, isopropyl alcohol, ethylene glycol(EG), water and mixtures thereof.

The dispersing agent is soluble in the solvent. Examples of the dispersing agent include but are not limited to BYK-9076, BYKJET-9151, Disperbyk-181, Disperbyk-2164 (available from Byk-Chemie company) and FGS 01 (a fluorine-containing material, available from Farsmart company).

For instance, the particle-containing solution may include 2 wt % to 25 wt % of the dispersing agent, 1 wt % to 45 wt % of the porous bodies 2, 1 wt % to 25 wt % of the heat shrinkable material and 5 wt % to 96 wt % of the solvent.

The heat shrinkable material-enclosed porous particles thus formed may be used as a filler or an additive in various polymeric products, such as fibers, yarns, filaments, polymeric films, polymeric coatings, polymeric slurry, polymeric foams, for enhancing desired properties and or functions, such as wicking, drying time reduction, anti-odor, warming, cooling, anti-mosquito, etc. For instance, the heat shrinkable material-enclosed porous particles maybe added into a melt of a polymeric material, such as poly(ethylene terephthalate) (PET), poly(butylenes terephthalate) (PBT), polypropylene (PP), polyamide , cellulose, acrylic resins, polyurethane, etc., for forming the polymeric filaments or fibers.

The following example is provided to illustrate the embodiments of the invention, and should not be construed as limiting the scope of the invention.

### EXAMPLE 1

2 wt % of FGS 01 that serves as the dispersing agent and is available from Farsmart company, 10 wt % of diatom powdered particles that serve as the porous particles and have a particle size of 10 2 wt % of THV 221AZ that serves as the heat shrinkable material and is available from 3M company, and 76 wt % of methyl ethyl ketone were mixed to form a mixture and the mixture was subsequently subjected to milling in a milling rotary drum for about 2 hours. The milling rotary drum was rotated at a speed of about 2000 rpm. After milling, the milled mixture was removed from the milling rotary drum and was dried to obtain the heat shrinkable material -enclosed porous particles having a particle size of about 900 nm.

### Shrinking Test

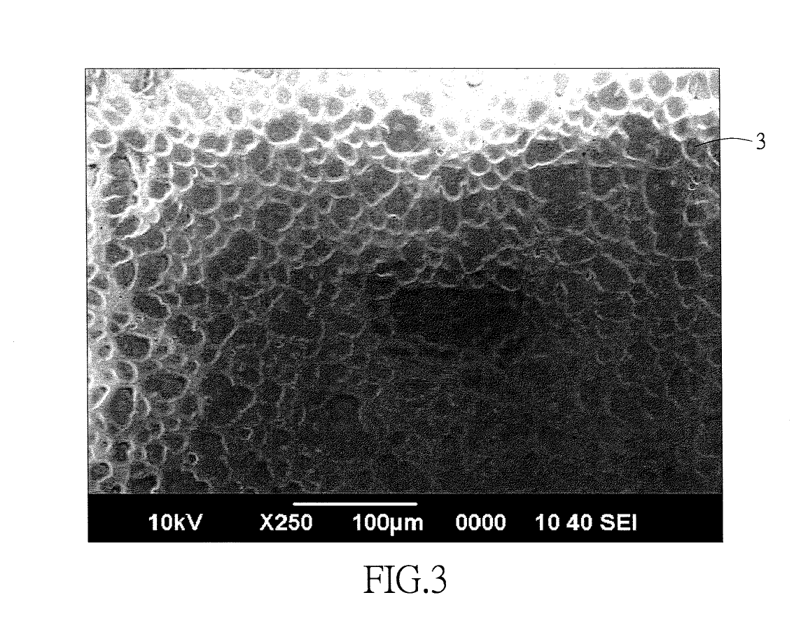

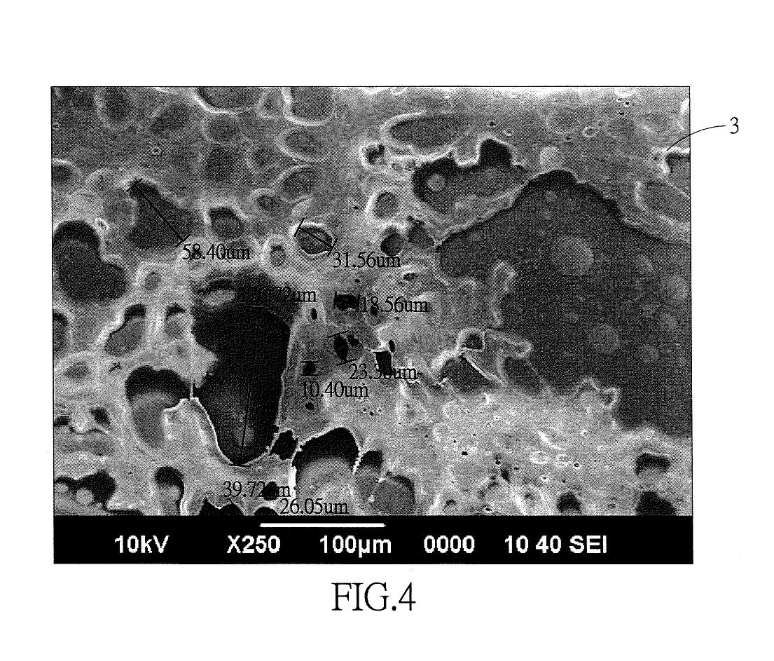

The heat shrinkable material-enclosed porous particles prepared in Example 1 was coated on a polymeric substrate, followed by heating under a temperature that was sufficient to cause shrinking of the heat shrinkable material 3 on the polymeric substrate. FIG. 3 is a scanning electron microscope (SEM) photograph showing surface morphology of the heat shrinkable material-enclosed porous particles coated on the polymeric substrate before a shrinking treatment. FIG. 4 is a scanning electron microscope (SEM) photograph showing the surface morphology of the heat shrinkable material-enclosed porous particles after the shrinking treatment with measured dimensions shown. The heat shrinkable material film 3 after the shrinking treatment exhibits a porous film formed with pores.

By virtue of enclosing the porous body 2 with the heat shrinkable material film 3, the pores in the porous body 2 are prevented from being clogged when the heat shrinkable material-enclosed porous particle is used as the filler or additive in various polymeric products, and the exposed pores in the porous body 2 are advantageous in maintaining or enhancing desired properties and or functions of the polymeric products, such as wicking, drying time reduction, anti-odor, warming, cooling, anti-mosquito, etc.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements

What is claimed is:

1. A heat shrinkable material-enclosed porous particle, comprising:
a porous body having a plurality of pores; and
a heat shrinkable material film that encloses said porous body.

2. The heat shrinkable material-enclosed porous particle of claim 1, wherein said porous body is made from a material selected from the group consisting of zeolite, aluminosilicate, diatom, eggshell-originated calcium carbonate, coffee residues, carbonized coffee residues, sepiolite (magnesium silica), kaolin, carbon black, active carbon, talc and mixtures thereof.

3. The heat shrinkable material-enclosed porous particle of claim 1, wherein the porous body has a particle size ranging from 5 nm to 50 μm.

4. The heat shrinkable material-enclosed porous particle of claim 3, wherein the particle size ranges from 50 nm to 200 nm.

5. The heat shrinkable material-enclosed porous particle of claim 1, wherein said porous body has a weight ratio relative to said heat shrinkable material film ranging from 1:1 to 10:1.

6. The heat shrinkable material-enclosed porous particle of claim 1, wherein the weight ratio ranges from 4:1 to 6:1.

7. The heat shrinkable material-enclosed porous particle of claim 1, wherein said heat shrinkable material film has a thickness ranging from 5 nm to 500 nm.

8. The heat shrinkable material-enclosed porous particle of claim 7, wherein the thickness ranges from 30 nm to 90 nm.

9. A method for preparing heat shrinkable material-enclosed porous particles, comprising:
preparing a particle-containing composition that includes a plurality of porous particles, each of which has a porous body with pores, a particle dispersing agent and a heat shrinkable material;
adding a solvent into the particle-containing composition to dissolve the heat shrinkable material to form a particle-containing solution;
subjecting the particle-containing solution to a wet milling process to reduce particle sizes of the porous particles; and
drying the particle-containing solution to remove the solvent and to permit formation of a heat shrinkable material film on the porous body of each of the porous particles such that the heat shrinkable material film encloses the porous body of each porous particle and covers a portion of the pores in the porous body.

10. The method for preparing heat shrinkable material-enclosed porous particles of claim 9, wherein the porous bodies of the porous particles have an original particle size ranging from 10 μm to 1000 μm before the wet milling process.

11. The method for preparing heat shrinkable material-enclosed porous particles of claim 9, wherein the wet milling process is conducted in a milling rotary drum having a rotation speed ranging from 500 rpm to 5000 rpm.

12. The method for preparing heat shrinkable material-enclosed porous particles of claim 11, wherein the rotation speed ranges from 1000 rpm to 3000 rpm.

13. The method for preparing heat shrinkable material-enclosed porous particles of claim 11, wherein a plurality of milling beads are placed in the milling rotary drum for grinding the porous particles, the milling beads having a diameter that ranges from 0.05 mm to 5 mm.

14. The method for preparing heat shrinkable material-enclosed porous particles of claim 9, wherein the solvent is selected from the group consisting of methyl ethyl ketone (MEK), toluene, alcohol, dimethylacetamide (DMAC), dimethylformamide (DMF), ethyl acetate, acetone, isopropyl alcohol, ethylene glycol (EG), water and mixtures thereof.

15. The method for preparing heat shrinkable material-enclosed porous particles of claim 9, wherein the particle-containing solution includes 2 to 25 wt % of the dispersing agent, 1 to 45 wt % of the porous particles, 1 to 25 wt % of the heat shrinkable material, and 5 to 96 wt % of the solvent.

16. A filler for a polymeric product, comprising a plurality of heat shrinkable material-enclosed porous particles as claimed in claim 1 and a polymeric material, the polymeric product being selected from fibers, yarns, filaments, polymeric films, polymeric coatings, polymeric slurry and polymeric foams.

17. The filler for the polymeric product, wherein the polymeric material is selected from the group consisting of poly(ethylene terephthalate) (PET), poly(butylenes terephthalate) (PBT), polypropylene (PP), polyamide, cellulose, acrylic resins, polyurethane (PU) and mixtures thereof.
